(19) United States
(12) Patent Application Publication
(10) Pub. No.: US 2026/0346585 A1
(43) Pub. Date: Nov. 5, 2026

(54) COMPOSITE HEAT-RESISTANT DIFFUSION PLATE AND PREPARATION PROCESS THEREFOR

(71) Applicant: GUANGDONG REGENCY ADVANCED MATERIALS CO, LTD., Huizhou (CN)

(72) Inventors: Xiaohong Wang, Huizhou (CN); Gaode Ling, Huizhou (CN); Xingli Wang, Huizhou (CN); Manyi Liang, Huizhou (CN)

(21) Appl. No.: 19/437,419

(22) Filed: Dec. 31, 2025

(30) Foreign Application Priority Data
Apr. 30, 2025 (CN) 202510571242.4

(51) Int. Cl. B32B 27/08; B32B 27/20; B32B 27/36

(52) U.S. Cl. CPC B32B 27/08; B32B 27/20; B32B 27/36; B32B 2250/03; B32B 2250/244; B32B 2262/101; B32B 2264/101; B32B 2264/107; B32B 2264/303; B32B 2307/304; B32B 2307/3065; B32B 2307/7375; B32B 2457/202

(57) ABSTRACT

The present disclosure relates to the technical field of diffusion plate preparation, and particularly relates to a composite heat-resistant diffusion plate and a preparation process therefor. The diffusion plate sequentially includes a three-layer structure from bottom to top: a core layer, an intermediate layer, and a surface layer from bottom to top, where the intermediate layer includes the following components in parts by mass: 55-60 parts of polyethylene terephthalate, 30-40 parts of polybutylene terephthalate, 1.5-2 parts of a titanate coupling agent, 5-8 parts of chopped glass fibers, 5-7 parts of a phosphorus-based flame retardant, and 0.5-1 part of maleic anhydride grafted SEBS. The composite heat-resistant diffusion plate provided by the present disclosure exhibits significant advantages in heat resistance, mechanical properties, optical properties, and environmental friendliness through innovative material selection, multi-layer structural design, and precise process control, thereby possessing a notable application prospect.

### CROSS-REFERENCE TO RELATED APPLICATION

This application claims priority to Chinese Patent Application No. 202510571242.4, filed on Apr. 30, 2024, which is hereby incorporated by reference in its entirety.

### TECHNICAL FIELD

The present disclosure relates to the technical field of diffusion plate preparation, and particularly relates to a composite heat-resistant diffusion plate and a preparation process therefor.

### BACKGROUND

Diffuse plates, as core components of liquid crystal displays, LED lighting, and imaging systems, have the essential function of achieving uniform and soft lighting effects by scattering incident light. Currently, general-purpose polystyrene (GPPS) is the mainstream base materials for manufacturing optical diffusion plates. However, it has significant drawbacks: insufficient heat resistance (with a thermal deformation temperature typically below 80 °C) and poor impact resistance (notched impact strength<2 kJ/m2). In long-term high-temperature working environments, GPPS-based diffusion plates are prone to thermal deformation, leading to optical performance degradation or even failure. During transportation or installation, brittle fractures can be easily caused by external impacts, significantly reducing the yield and the service life.

In recent years, polyester materials have been considered as potential substitutes for polystyrene (GPPS) in the preparation of diffusion plates due to their excellent comprehensive properties. Taking polybutylene terephthalate (PBT resin) as an example, PBT is formed by the condensation polymerization of terephthalic acid and 1,4-butanediol. A linear structure of the main chain containing ester endows PBT with a high melting point (225-230 °C), low water absorption (<0.1%), and excellent chemical corrosion resistance, with no risk of stress cracking and outstanding long-term thermal aging stability. However, the effective application of PBT in the field of light diffusion plates has not been realized in the existing research. Experiments show that the diffusion plates directly prepared with PBT instead of GPPS exhibit a significant decrease in light diffusion effects. The main reasons include: firstly, the refractive index is mismatched, where the light scattering efficiency is reduced due to the difference between the PBT resin (refractive index of 1.55) and traditional glass microbeads (refractive index of 1.50-1.53); and secondly, the interface compatibility is poor, where a conventional light diffusant (such as inorganic particles) tends to agglomerate in a PBT matrix, causing uneven distribution and leading to haze fluctuation (deviation>20%) and decreased light transmittance (<80%).

Therefore, creating a diffusion plate that overcomes the above defects not only has significant environmental implications but also possesses high economic value.

### SUMMARY

To overcome the defects of the prior art, the present disclosure aims to provide a composite heat-resistant diffusion plate and a preparation process therefor. The diffusion plate sequentially includes a three-layer structure from bottom to top: a core layer, an intermediate layer, and a surface layer, where the intermediate layer includes the following components in parts by mass: 55-60 parts of polyethylene terephthalate, 30-40 parts of polybutylene terephthalate, 1.5-2 parts of a titanate coupling agent, 5-8 parts of chopped glass fibers, 5-7 parts of a phosphorus-based flame retardant, and 0.5-1 part of maleic anhydride grafted SEBS. The composite heat-resistant diffusion plate provided by the present disclosure exhibits significant advantages in heat resistance, mechanical properties, optical properties, and environmental friendliness through innovative material selection, multi-layer structural design, and precise process control, thereby having a notable application prospect.

To achieve the above objective, the present disclosure provides the following technical solution.

A composite heat-resistant diffusion plate sequentially includes, from bottom to top, a core layer, an intermediate layer, and a surface layer; where
the core layer includes the following components in parts by mass: 40-50 parts of bisphenol A-type unsaturated polyester, 10-20 parts of polybutylene succinate, 5-7 parts of glass microbeads, 1.2-1.5 parts of dicumyl peroxide, 3-5 parts of nano cerium oxide, and 0.8-1 part of kaolin;
the intermediate layer includes the following components in parts by mass:

55-60 parts of polyethylene terephthalate, 30-40 parts of polybutylene terephthalate, 1.5-2 parts of a titanate coupling agent, 5-8 parts of chopped glass fibers, 5-7 parts of a phosphorus-based flame retardant, and 0.5-1 part of maleic anhydride grafted SEBS; and

the surface layer includes the following components in parts by mass: 30-40 parts of poly(ethylene terephthalate-co-1,4-cyclohexanedimethanol), 3-5 parts of nano boron nitride, 8-10 parts of a silicone-based light diffusant, 1.5-2 parts of an antioxidant, and 3.5-4 parts of a modified compatibilizer.

Preferably, the maleic anhydride grafted SEBS is prepared by the following steps:
S11, dissolving 80-100 parts by mass of SEBS in 500-600 parts of a toluene solution with a mass concentration of 10-20%, and uniformly stirring to form a uniform solution;
S12, sequentially adding 5-8 parts of maleic anhydride and 0.3-1 part of benzoyl peroxide into the solution treated in step S11, uniformly stirring, then heating the mixture to 110-130 °C in an oil bath under the protection of nitrogen, and carrying out reaction for 3-6 hours to obtain a reaction solution; and
S13, separating out a polymer from the reaction solution with acetone, washing the polymer with ethanol for 3-4 times, and drying the polymer in vacuum at 60-80 °C to constant weight to obtain the maleic anhydride grafted SEBS.

Preferably, the modified compatibilizer is prepared by the following steps:
S21, dissolving 60-80 parts by mass of an ethylene-vinyl acetate copolymer in 400-500 parts of a toluene solution with a mass concentration of 10-20%, and uniformly stirring to form a uniform solution;
S22, sequentially adding 5-8 parts of glycidyl methacrylate and 0.5-1.5 parts of benzoyl peroxide into the solution treated in step S21, uniformly stirring, heating the mixture to 110-130 °C in an oil bath under the protection of nitrogen, and carrying out reaction for 4-8 hours to obtain a modified compatibilizer solution; and
S23, separating out a polymer from the modified compatibilizer solution with methanol, washing the polymer with ethanol for 3-4 times, and drying the polymer in vacuum at 60-80 °C to constant weight to obtain the modified compatibilizer.

Preferably, the glass microbeads have a particle size of 15-45 μm; and the kaolin has a particle size of 1.5-3 μm.

Preferably, the titanate coupling agent is further defined as a mono-alkoxy pyrophosphate ester-type coupling agent.

Preferably, the chopped glass fibers have a length of 2.5-3.5 mm and a diameter of 10-13 μm; and the phosphorus-based flame retardant is further defined as a phosphate flame retardant.

Preferably, the silicone-based light diffusant is further defined as an organic silicon composite type light diffusant; and the antioxidant is selected from one or more of pentaerythritol tetra[β-(3,5-di-tert-butyl-4-hydroxyphenyl) propionate] and octadecyl β-(3,5-di-tert-butyl-4-hydroxyphenyl) propionate.

A preparation process for a composite heat-resistant diffusion plate used for producing the composite heat-resistant diffusion plate includes the following steps:
S1, raw material premixing: respectively feeding the raw materials of the core layer, the intermediate layer, and the surface layer into a high-speed mixer according to parts by mass, and stirring for 10-20 minutes for premixing to obtain a corresponding core layer premix, an intermediate layer premix, and a surface layer premix;
S2, extrusion granulation: respectively processing the core layer premix and the intermediate layer premix through a double-screw extruder for extrusion granulation, and processing the surface layer premix through a single-screw extruder for extrusion granulation to obtain core layer granules, intermediate layer granules, and surface layer granules; and
S3, embossing and molding: respectively feeding the core layer granules and the intermediate layer granules into the double-screw extruder, feeding the surface layer granules into the single-screw extruder, heating and melting for three-layer co-extrusion, and embossing to obtain the composite heat-resistant diffusion plate.

Preferably, in step S2, temperature zones of the double-screw extruder used for preparing the core layer granules are: a first zone at 160-180 °C, a second zone at 190-200 °C, a third zone at 210-220 °C, and a die temperature at 215-220 °C; temperature zones of the double-screw extruder used for preparing the intermediate layer granules are: a first zone at 240-250 °C, a second zone at 260-270 °C, a third zone at 260-265 °C, and a die temperature at 265-270 °C; and

temperature zones of the single-screw extruder used for preparing the surface layer granules are: a first zone at 200-210 °C, a second zone at 220-230 °C, a third zone at 230-240 °C, and a die temperature at 225-230 °C.

Preferably, in step S3, temperature zones of the double-screw extruder used for melting the core layer granules are: a first zone at 190-200 °C, a second zone at 210-220 °C, and a die temperature at 205-210 °C;
temperature zones of the double-screw extruder used for melting the intermediate layer granules are: a first zone at 260-270 °C, a second zone at 275-280 °C, and a die temperature at 265-270 °C; and
temperature zones of the single-screw extruder used for melting the surface layer granules are: a first zone at 220-230 °C, a second zone at 235-240 °C, and a die temperature at 235-240 °C.

Compared with the prior art, the present disclosure has the following beneficial effects:

1. The core layer uses a cross-linking system of the bisphenol A-type unsaturated polyester and polybutylene succinate, constructing a three-dimensional network structure through a free radical initiator, significantly enhancing thermal stability and deformation resistance of the material. The synergistic effect of the glass microbeads and the nano cerium oxide enhances the rigidity of the matrix while delaying photoaging through refractive index matching and an ultraviolet absorption mechanism.

2. The intermediate layer is reinforced by the composite of a polyester alloy matrix and the chopped glass fibers, combined with the gas-phase and condensed-phase synergistic flame-retardant mechanism of the phosphorus-based flame retardant, achieving efficient flame retardancy while maintaining high light transmittance. The maleic anhydride grafted SEBS effectively improves the interface compatibility between the fibers and the resin through the physical entanglement and chemical bonding of polar functional groups with polyester molecular chains, inhibiting mechanical failure caused by stress concentration.

3. The surface layer is based on the scattering phase control of the organic silicon composite light diffusant and the hard phase enhancement of the nano boron nitride, improving surface wear resistance while ensuring uniform light diffusion. The antioxidant inhibits thermal oxidative degradation through free radical capture and peroxide decomposition mechanisms, while the modified compatibilizer achieves interlayer chemical bond bridging through the reaction of epoxy groups with polyester end groups, ensuring the interfacial bonding strength of the multi-layer structure.

4. Through layered granulation and gradient temperature control co-extrusion technology, the present disclosure enables the material of each layer to adhere tightly during extrusion molding, creating a stable composite structure. This ultimately achieves a balanced enhancement of heat resistance, impact resistance and optical performance. In addition, the entire production process uses environment-friendly materials, which is free of harmful substances such as halogen, making the product both safe and durable.

### BRIEF DESCRIPTION OF THE DRAWINGS

FIG. 1 is a flowchart of a preparation process for a composite heat-resistant diffusion plate of the present disclosure.

FIG. 2 is a flowchart of a preparation process for maleic anhydride grafted SEBS of the present disclosure.

FIG. 3 is a flowchart of a preparation process for a modified compatibilizer of the present disclosure.

### DESCRIPTION OF EMBODIMENTS

The present disclosure will be clearly and completely described below in conjunction with examples of the present disclosure. Obviously, the described examples are only a part of, not all of, the examples of the present disclosure. All other examples obtained by those skilled in the art based on the examples of the present disclosure without creative efforts shall fall within the protection scope of the present disclosure.

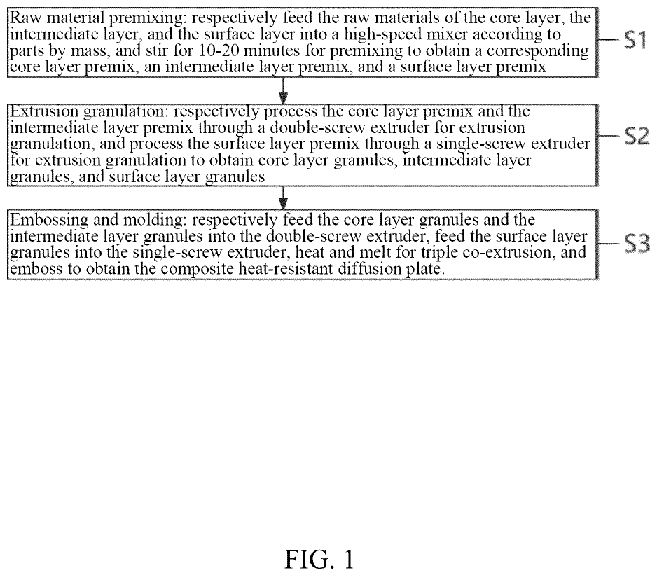

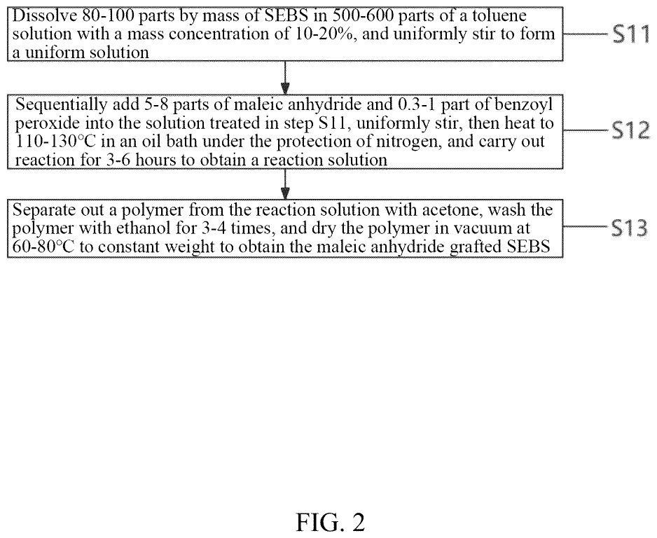

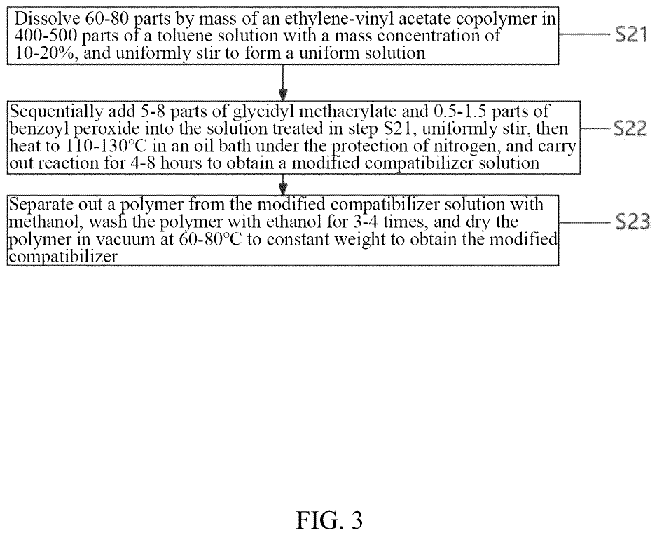

Referring to FIGS. 1-3, the present disclosure provides a technical solution.

### Example 1

A preparation process for a composite heat-resistant diffusion plate includes:
S1, raw material premixing: raw materials of a core layer, an intermediate layer, and a surface layer were respectively fed into a high-speed mixer according to parts by mass, and stirred for 10 minutes for premixing to obtain a corresponding core layer premix, an intermediate layer premix, and a surface layer premix;
S2, extrusion granulation: the core layer premix and the intermediate layer premix were respectively processed through a double-screw extruder for extrusion granulation, and the surface layer premix was processed through a single-screw extruder for extrusion granulation to obtain core layer granules, intermediate layer granules, and surface layer granules; and
S3, embossing and molding: the core layer granules and the intermediate layer granules were respectively fed into the double-screw extruder, the surface layer granules were fed into the single-screw extruder, heated and melted for three-layer co-extrusion, and embossed to obtain the composite heat-resistant diffusion plate.

During the above process, in step S2, temperature zones of the double-screw extruder used for preparing the core layer granules were: a first zone at 160 °C, a second zone at 190 °C, a third zone at 210 °C, and a die temperature at 215 °C.

Temperature zones of the double-screw extruder used for preparing the intermediate layer granules were: a first zone at 240 °C, a second zone at 260 °C, a third zone at 265 °C, and a die temperature at 270 °C.

Temperature zones of the single-screw extruder used for preparing the surface layer granules were: a first zone at 210 °C, a second zone at 220 °C, a third zone at 230 °C, and a die temperature at 230 °C.

During the above process, in step S3, temperature zones of the double-screw extruder used for melting the core layer granules were: a first zone at 190 °C, a second zone at 210 °C, and a die temperature at 205 °C.

Temperature zones of the double-screw extruder used for melting the intermediate layer granules were: a first zone at 260 °C, a second zone at 275 °C, and a die temperature at 265 °C.

Temperature zones of the single-screw extruder used for melting the surface layer granules were: a first zone at 220 °C, a second zone at 235 °C, and a die temperature at 240 °C.

During the above process, the technical effect of the three-layer co-extrusion was achieved through a T-shaped hanger-type co-extrusion die, with a runner designed as a ratio of core layer, the intermediate layer, and the surface layer being 45%: 35%: 20%, a die lip clearance tolerance being ±0.02 mm, and a traction speed being 5 m/min. The working parameters of the embossing molding were: a die pressure at 18 MPa, a traction roller pressure at 0.8 MPa, and a cooling water temperature at 15 °C.

During the above process, the composite heat-resistant diffusion plate, after being obtained, may further be annealed in hot air circulation at 140 °C for 1 hour to eliminate the internal stress in the diffusion plate.

During the above process, the raw materials of the core layer respectively included the following components in parts by mass (where the mass of one part was defined as 500 g):

| | Amount |
|---|---|
| Component | (parts by mass) |
| Bisphenol A-type unsaturated polyester | 40 |
| Polybutylene succinate | 10 |
| Glass microbeads | 5 |
| Dicumyl peroxide | 1.2 |
| Nano cerium oxide | 3 |
| Kaolin | 0.8 |

The bisphenol A-type unsaturated polyester was under the brand name of UPGF-90.

The polybutylene succinate was purchased from Mitsubishi Chemical Corporation.

The glass microbeads had a particle size of 15-45 μm and a model of iM30K, and were purchased from PQ Corporation.

The nano cerium oxide had a particle size of 0.4-0.8 μm.

The kaolin had a particle size of 1.5-3 μm.

During the above process, the raw materials of the intermediate layer respectively included the following components in parts by mass (where the mass of one part was defined as 500 g):

| | Amount |
|---|---|
| Component | (parts by mass) |
| Polyethylene terephthalate | 55 |
| Polybutylene terephthalate | 30 |
| Titanate coupling agent | 1.5 |
| Chopped glass fibers | 5 |
| Phosphorus-based flame retardant | 5 |
| Maleic anhydride grafted SEBS | 0.5 |

During the above process, the polyethylene terephthalate is under the brand name of Rynite®935.

During the above process, the polybutylene terephthalate is under the brand name of SK605.

The titanate coupling agent was further defined as a mono-alkoxy pyrophosphate coupling agent, particularly PN-201.

The chopped glass fibers had a length of 3 mm, a diameter of 11 μm, and a model of ECS303-3H.

The phosphorus-based flame retardant was further defined as a phosphate flame retardant, specifically resorcinol bis(diphenyl phosphate).

The maleic anhydride grafted SEBS was prepared by the following method:
S11, 80 parts by mass of SEBS was dissolved in 500 parts of a toluene solution with a mass concentration of 10%, and uniformly stirred to form a uniform solution;
S12, 5 parts of maleic anhydride and 0.3 part of benzoyl peroxide were sequentially added into the solution treated in step S11, uniformly stirred, then heated to 110 °C in an oil bath under the protection of nitrogen, and subjected to reaction for 3 hours to obtain a reaction solution; and
S13, a polymer was separated out from the reaction solution with excessive acetone, washed with ethanol for 3 times, and dried in vacuum at 60 °C to constant weight to obtain the maleic anhydride grafted SEBS.

During the above process, the SEBS had a model of TSRC 6151.

During the above process, the raw materials of the surface layer respectively included the following components in parts by mass (where the mass of one part was defined as 500 g):

| | Amount |
|---|---|
| Component | (parts by mass) |
| poly (ethylene terephthalate- | 30 |
| co-1,4-cyclohexanedimethanol) | |
| Nano boron nitride | 3 |
| Silicone-based light diffusant | 8 |
| Antioxidant | 1.5 |
| Modified compatibilizer | 3.5 |

The poly(ethylene terephthalate-co-1,4-cyclohexanedimethanol) had a model of PCTG VX 401.

The silicone-based light diffusant was further defined as an organic silicon composite light diffusant, with a specific model of X-52-7056A.

The antioxidant was tetra[β-(3,5-di-tert-butyl-4-hydroxyphenyl) propionate] pentaerythritol ester.

The modified compatibilizer was prepared by the following steps:
S21, 60 parts by mass of an ethylene-vinyl acetate copolymer was dissolved in 400 parts of a toluene solution with a mass concentration of 10%, and uniformly stirred to form a uniform solution;
S22, 5 parts of glycidyl methacrylate and 0.5 part of benzoyl peroxide were sequentially added into the solution treated in step S21, uniformly stirred, then heated to 110 °C in an oil bath under the protection of nitrogen, and subjected to reaction for 4 hours to obtain a modified compatibilizer solution; and
S23, a polymer was separated out from the modified compatibilizer solution with excessive methanol, washed with ethanol for 3 times, and dried in vacuum at 60 °C to constant weight to obtain the modified compatibilizer.

During the above process, the ethylene-vinyl acetate copolymer was purchased from Mitsubishi Chemical Corporation.

Example 2: Example 2 differed from Example 1 only in the following aspects: in Example 2, the raw materials of the core layer respectively included the following components in parts by mass (where the mass of one part was defined as 500 g):

| | Amount |
|---|---|
| Component | (parts by mass) |
| Bisphenol A-type unsaturated polyester | 45 |
| Polybutylene succinate | 15 |
| Glass microbeads | 6 |
| Dicumyl peroxide | 1.3 |
| Nano cerium oxide | 4 |
| Kaolin | 0.9 |

The raw materials of the intermediate layer respectively included the following components in parts by mass (where the mass of one part was defined as 500 g):

| | Amount |
|---|---|
| Component | (parts by mass) |
| Polyethylene terephthalate | 58 |
| Polybutylene terephthalate | 34 |
| Titanate coupling agent | 1.7 |
| Chopped glass fibers | 6 |
| Phosphorus-based flame retardant | 5.5 |
| Maleic anhydride grafted SEBS | 0.7 |

The raw materials of the surface layer respectively included the following components in parts by mass (where the mass of one part was defined as 500 g):

| | Amount |
|---|---|
| Component | (parts by mass) |
| poly (ethylene terephthalate- | 35 |
| co-1,4-cyclohexanedimethanol) | |
| Nano boron nitride | 4 |
| Silicone-based light diffusant | 9 |
| Antioxidant | 1.6 |
| Modified compatibilizer | 3.7 |

The remaining steps were completely the same in Example 2 and Example 1.

Example 3: Example 3 differed from Example 1 only in the following aspects: Example 3, the raw materials of the core layer respectively included the following components in parts by mass (where the mass of one part was defined as 500 g):

| | Amount |
|---|---|
| Component | (parts by mass) |
| Bisphenol A-type unsaturated polyester | 50 |
| Polybutylene succinate | 20 |
| Glass microbeads | 7 |
| Dicumyl peroxide | 1.5 |
| Nano cerium oxide | 4.5 |
| Kaolin | 1.0 |

The raw materials of the intermediate layer respectively included the following components in parts by mass (where the mass of one part was defined as 500 g):

| | Amount |
|---|---|
| Component | (parts by mass) |
| Polyethylene terephthalate | 60 |
| Polybutylene terephthalate | 40 |
| Titanate coupling agent | 2 |
| Chopped glass fibers | 8 |
| Phosphorus-based flame retardant | 7 |
| Maleic anhydride grafted SEBS | 1 |

The raw materials of the surface layer respectively included the following components in parts by mass (where the mass of one part was defined as 500 g):

| | Amount |
|---|---|
| Component | (parts by mass) |
| poly (ethylene terephthalate- | 40 |
| co-1,4-cyclohexanedimethanol) | |
| Nano boron nitride | 5 |
| Silicone-based light diffusant | 10 |
| Antioxidant | 2 |
| Modified compatibilizer | 4 |

The remaining steps were exactly the same in Example 3 and Example 1.

Example 4: Example 4 differed from Example 1 only in the following aspects: in Example 4, the raw materials of the core layer respectively included the following components in parts by mass (where the mass of one part was defined as 500 g):

| | Amount |
|---|---|
| Component | (parts by mass) |
| Bisphenol A-type unsaturated polyester | 47 |
| Polybutylene succinate | 14 |
| Glass microbeads | 5.5 |
| Dicumyl peroxide | 1.4 |
| Nano cerium oxide | 4 |
| Kaolin | 0.9 |

The raw materials of the intermediate layer respectively included the following components in parts by mass (where the mass of one part was defined as 500 g):

| | Amount |
|---|---|
| Component | (parts by mass) |
| Polyethylene terephthalate | 56 |
| Polybutylene terephthalate | 37 |
| Titanate coupling agent | 1.8 |
| Chopped glass fibers | 7 |
| Phosphorus-based flame retardant | 6 |
| Maleic anhydride grafted SEBS | 1 |

The raw materials of the surface layer respectively included the following components in parts by mass (where the mass of one part was defined as 500 g):

| | Amount |
|---|---|
| Component | (parts by mass) |
| poly (ethylene terephthalate- | 37 |
| co-1,4-cyclohexanedimethanol) | |
| Nano boron nitride | 5 |
| Silicone-based light diffusant | 8.5 |
| Antioxidant | 1.8 |
| Modified compatibilizer | 4 |

The remaining steps were exactly the same in Example 4 and Example 1.

### Contrasts

Contrast 1: Contrast 1 differed from Example 1 only in the following aspects: in Contrast 1, the preparation of the core layer was eliminated, and the remaining steps were completely the same in Contrast 1 and Example 1.

Contrast 2: Contrast 2 differed from Example 1 only in the following aspects: in Contrast 2, the preparation of the surface layer was eliminated, and the remaining steps were completely the same in Contrast 2 and Example 1.

Contrast 3: Contrast 3 differed from Example 1 only in the following aspects: in Contrast 3, the preparations of the core layer and surface layer were eliminated, and the remaining steps were completely the same in Contrast 3 and Example 1.

### Performance Tests:

According to the requirements of GB/T 2410-2008 and GB/T 2410-2008 standards, the light transmittance and the haze of the prepared composite heat-resistant diffusion plate were tested; according to the requirements of GB/T 1843-2008 and GB/T 9341-2008 standards, the notched impact strength and the bending strength of the prepared composite heat-resistant diffusion plate were tested; according to the requirements of GB/T 1634.2-2019 and GB/T 2423.3-2016 standards, the thermal deformation temperature and long-term heat resistance of the prepared composite heat-resistant diffusion plate were tested; and according to the requirements of GB/T 2408-2021 standard, the flame retardant of the prepared composite heat-resistant diffusion plate was tested. The test results were as follows:

| | Example | Example | Example | Example | Contrast | Contrast | Contrast |
|---|---|---|---|---|---|---|---|
| Item | 1 | 2 | 3 | 4 | 1 | 2 | 3 |
| Light | 88.5 | 89.2 | 87.8 | 88.9 | 78.3 | 82.1 | 70.5 |
| transmittance | | | | | | | |
| (%) | | | | | | | |
| Haze (%) | 92.3 | 91.5 | 93.0 | 92.7 | 85.4 | 88.9 | 80.2 |
| Notched | 48.6 | 51.2 | 45.3 | 49.8 | 22.7 | 30.5 | 15.4 |
| impact | | | | | | | |
| strength | | | | | | | |
| (kJ/m2) | | | | | | | |
| Bending | 125 | 132 | 118 | 128 | 85 | 98 | 72 |
| strength | | | | | | | |
| (MPa) | | | | | | | |
| HDT (°C, | 158 | 162 | 165 | 160 | 112 | 135 | 95 |
| 1.8 MPa) | | | | | | | |
| Retention | 92.1 | 93.5 | 90.8 | 92.9 | 68.5 | 75.2 | 60.3 |
| rate of light | | | | | | | |
| transmittance | | | | | | | |
| after | | | | | | | |
| long-term | | | | | | | |
| heat | | | | | | | |
| resistance | | | | | | | |
| (%) | | | | | | | |
| UL94 | V-0 | V-0 | V-0 | V-0 | V-2 | V-1 | Fail |
| vertical | | | | | | | |
| burning | | | | | | | |
| rating | | | | | | | |

As can be seen from the performance test data of Examples 1-4, their light transmittance is higher than 87%, the haze is higher than 91%, the notched impact strength is higher than 45 KJ/m2, the bending strength is higher than 118 MPa, the HDT is higher than 158 °C, the heat-resistant retention rate is higher than 90%, and the UL94 vertical burning rating has reached V-0, with excellent and stable performance. This indicates that the composite heat-resistant diffusion plate provided by the present disclosure exhibits significant advantages in heat resistance, mechanical properties, optical properties, and environmental friendliness through innovative material selection, multi-layer structure design, and precise process control, thereby having a notable application prospect.

The light transmittance and the haze of the Examples 1-4 are significantly better than those of Contrasts 1-3, which is due to the synergistic regulation of the optical properties by the layered design. In the examples, the core layer forms a rigid framework through a cross-linked network of the bisphenol A-type unsaturated polyester (UPGF-90) and the polybutylene succinate (PBS). The glass microbeads (15-45 μm) and the nano cerium oxide (0.4-0.8 μm) achieve directional light scattering through refractive index matching (the refractive index of the core layer resin is 1.56, and of the glass microbeads is 1.52), while the nano cerium oxide absorbs the energy of an ultraviolet band (200-400 nm), inhibiting light degradation, and ensuring long-term light transmittance retention rate (90.8-93.5%). Contrast 1 (without a core layer) lacks this structure, resulting in Fresnel reflection loss when light passes through the intermediate layer due to the difference between the PET/PBT matrix (refractive index being 1.57) and the air interface (refractive index being 1.0), which leads to a decrease in light transmittance to 78.3%. In addition, without the ultraviolet shielding effect of the nano cerium oxide, the retention rate of light transmittance after long-term damp-heat aging is only 68.5%.

The notched impact strength and the bending strength of Examples 1-4 are significantly better than those of Contrasts 1-3, which is presumed to be due to the synergistic toughening mechanism at the interface between the core layer and the intermediate layer. The PBS in the core layer serves as an elastic phase, dispersing the impact energy through molecular chain entanglement. The maleic anhydride grafted SEBS (the grafting rate≥1.5%) in the intermediate layer forms chemical bonds through reaction of acid anhydride groups with the PET/PBT end hydroxyl groups, enhancing the interface bonding between the glass fibers (ECS303-3H) and the resin, and inhibiting crack propagation. Taking Example 2 as an example, with PBS content increased to 15 parts, its plasticizing effect increases the impact strength to 51.2 KJ/m2. Contrast 3, which completely lacks the core layer and the surface layer, relies solely on the physical enhancement of the glass fibers (5-8 parts) in the intermediate layer. A weak bonding area exists between the glass fiber and the resin interface, leading to stress concentration and a bending strength of merely 72 MPa.

The thermal distortion temperature of Examples 1-4 is significantly higher than that of Contrasts 1-3, which is because the rigid benzene ring structure and cross-linking network (DCP-induced free radical cross-linking) of the bisphenol A resin in the core layer restrict the movement of molecular chains. The phosphorus-based flame retardant (resorcinol bis(diphenyl phosphate) in the intermediate layer generates a phosphate char layer when burning, isolating oxygen and catalyzing the dehydration and carbonization of PET/PBT, and achieving UL94 V-0 flame retardance. However, Contrast 1, without a core layer, has incomplete char layer coverage when the flame retardant in the intermediate layer acts alone, leading to melting droplets igniting cotton wool during vertical burning, which achieves only V-2 rating. Contrast 3 fails the flame retardance test.

Although the examples of the present disclosure have been shown and described, it is understood by those skilled in the art that various changes, modifications, substitutions and alterations can be made to these examples without departing from the principles and spirit of the present disclosure. The scope of the present disclosure is defined by the appended claims and their equivalents.

What is claimed is:

1. A composite heat-resistant diffusion plate, sequentially comprising, from bottom to top, a core layer, an intermediate layer, and a surface layer; wherein:
the core layer comprises the following components in parts by mass: 40-50 parts of bisphenol A-type unsaturated polyester, 10-20 parts of polybutylene succinate, 5-7 parts of glass microbeads, 1.2-1.5 parts of dicumyl peroxide, 3-5 parts of nano cerium oxide, and 0.8-1 part of kaolin;
the intermediate layer comprises the following components in parts by mass: 55-60 parts of polyethylene terephthalate, 30-40 parts of polybutylene terephthalate, 1.5-2 parts of a titanate coupling agent, 5-8 parts of chopped glass fibers, 5-7 parts of a phosphorus-based flame retardant, and 0.5-1 part of maleic anhydride grafted SEBS; and
the surface layer comprises the following components in parts by mass: 30-40 parts of poly(ethylene terephthalate-co-1,4-cyclohexanedimethanol), 3-5 parts of nano boron nitride, 8-10 parts of a silicone-based light diffusant, 1.5-2 parts of an antioxidant, and 3.5-4 parts of a modified compatibilizer.

2. The composite heat-resistant diffusion plate according to claim 1, wherein the maleic anhydride grafted SEBS is prepared by the following steps:
S11, dissolving 80-100 parts by mass of SEBS in 500-600 parts of a toluene solution with a mass concentration of 10-20%, and uniformly stirring to form a uniform solution;
S12, sequentially adding 5-8 parts of maleic anhydride and 0.3-1 part of benzoyl peroxide into the solution treated in step S11, uniformly stirring, then heating the mixture to 110-130 °C in an oil bath under the protection of nitrogen, and carrying out reaction for 3-6 hours to obtain a reaction solution; and
S13, separating out a polymer from the reaction solution with acetone, washing the polymer with ethanol for 3-4 times, and drying the polymer in vacuum at 60-80 °C to constant weight to obtain the maleic anhydride grafted SEBS.

3. The composite heat-resistant diffusion plate according to claim 1, wherein the modified compatibilizer is prepared by the following steps:
S21, dissolving 60-80 parts by mass of an ethylene-vinyl acetate copolymer in 400-500 parts of a toluene solution with a mass concentration of 10-20%, and uniformly stirring to form a uniform solution;
S22, sequentially adding 5-8 parts of glycidyl methacrylate and 0.5-1.5 parts of benzoyl peroxide into the solution treated in step S21, uniformly stirring, then heating the mixture to 110-130 °C in an oil bath under the protection of nitrogen, and carrying out reaction for 4-8 hours to obtain a modified compatibilizer solution; and
S23, separating out a polymer from the modified compatibilizer solution with methanol, washing the polymer with ethanol for 3-4 times, and drying the polymer in vacuum at 60-80 °C to constant weight to obtain the modified compatibilizer.

4. The composite heat-resistant diffusion plate according to claim 1, wherein the glass microbeads have a particle size of 15-45 μm; and the kaolin has a particle size of 1.5-3 μm.

5. The composite heat-resistant diffusion plate according to claim 1, wherein the titanate coupling agent is further defined as a mono-alkoxy pyrophosphate ester-type coupling agent.

6. The composite heat-resistant diffusion plate according to claim 1, wherein the chopped glass fibers have a length of 2.5-3.5 mm and a diameter of 10-13 μm; and the phosphorus-based flame retardant is further defined as a phosphate flame retardant.

7. The composite heat-resistant diffusion plate according to claim 1, wherein the silicone-based light diffusant is further defined as an organic silicon composite type light diffusant; and the antioxidant is selected from one or more of pentaerythritol tetra[β-(3,5-di-tert-butyl-4-hydroxyphenyl) propionate] and octadecyl β-(3,5-di-tert-butyl-4-hydroxyphenyl) propionate.

8. A preparation process for a composite heat-resistant diffusion plate, used for producing the composite heat-resistant diffusion plate according to claim 1, comprising the following steps:
S1, raw material premixing: respectively feeding the raw materials of the core layer, the intermediate layer, and the surface layer into a high-speed mixer according to parts by mass, and stirring for 10-20 minutes for premixing to obtain a corresponding core layer premix, an intermediate layer premix, and a surface layer premix;
S2, extrusion granulation: respectively processing the core layer premix and the intermediate layer premix through a double-screw extruder for extrusion granulation, and processing the surface layer premix through a single-screw extruder for extrusion granulation to obtain core layer granules, intermediate layer granules, and surface layer granules; and
S3, embossing and molding: respectively feeding the core layer granules and the intermediate layer granules into the double-screw extruder, feeding the surface layer granules into the single-screw extruder, heating and melting for three-layer co-extrusion, and embossing to obtain the composite heat-resistant diffusion plate.

9. The preparation process for the composite heat-resistant diffusion plate according to claim 8, wherein in step S2, temperature zones of the double-screw extruder used for preparing the core layer granules are: a first zone at 160-180 °C, a second zone at 190-200 °C, a third zone at 210-220 °C, and a die temperature at 215-220 °C;
temperature zones of the double-screw extruder used for preparing the intermediate layer granules are: a first zone at 240-250 °C, a second zone at 260-270 °C, a third zone at 260-265 °C, and a die temperature at 265-270 °C; and
temperature zones of the single-screw extruder used for preparing the surface layer granules are: a first zone at 200-210 °C, a second zone at 220-230 °C, a third zone at 230-240 °C, and a die temperature at 225-230 °C.

10. The preparation process for the composite heat-resistant diffusion plate according to claim 8, wherein in step S3, temperature zones of the double-screw extruder used for melting the core layer granules are: a first zone at 190-200 °C, a second zone at 210-220 °C, and a die temperature at 205-210 °C;
temperature zones of the double-screw extruder used for melting the intermediate layer granules are: a first zone at 260-270 °C, a second zone at 275-280 °C, and a die temperature at 265-270 °C; and
temperature zones of the single-screw extruder used for melting the surface layer granules are: a first zone at 220-230 °C, a second zone at 235-240 °C, and a die temperature at 235-240 °C.
